(19) United States
(12) Patent Application Publication
(10) Pub. No.: US 2011/0268387 A1
(43) Pub. Date: Nov. 3, 2011

(54) Two Dimensional Fiber Collimator Array With High Return Loss

(76) Inventor: Gregor Popp, Munich (DE)

(21) Appl. No.: 12/769,276

(22) Filed: Apr. 28, 2010

(51) Int. Cl. G02B 6/32

(52) U.S. Cl. 385/33

(57) ABSTRACT

A collimator system comprises a micro lens array. The micro lens array has a first surface with a plurality of micro lenses and a second surface opposing the first surface. The second surface is under an angle towards the first surface. A fiber holder holding a plurality of parallel optical fibers has a first surface having an angle with respect to the longitudinal axis of the optical fibers. The fiber holder is attached to the micro lens array in such a way that the angle of the second surface of the micro lens array and the first surface of the fiber holder compensate.

### BACKGROUND OF THE INVENTION

1. Field of the Invention

The invention relates to a fiber optic collimator system particularly for use in optical rotary joints, optical rotary joints and a method for manufacturing a fiber collimator array.

2. Description of Related Art

Various transmission systems are known for transmission of optical signals between units that are rotatable relative to each other.

U.S. Pat. No. 5,371,814 discloses an optical rotary joint for a plurality of channels, having a Dove prism. An arrangement having a plurality of GRIN lenses is provided for coupling light into or out of glass fibers. Beam coupling or decoupling is performed by several separate lenses. These lenses must be adjusted individually. A precise adjustment requires a comparatively large amount of time. Furthermore the lenses consume a lot of space. As a result, the area to be projected, i.e. the entire surface projected via the derotating system, increases as the number of channels and the precision in adjustment increases. Therefore, a larger optical system is necessary, which also has a higher optical attenuation as a result of the longer optical paths and, at the same time, involves higher demands on the precision in adjustment.

U.S. Pat. No. 5,442,721 discloses another optical rotary joint having bundled collimators assemblies. These allow a further decrease in size and increase in optical quality.

U.S. Pat. No. 7,246,949 B2 discloses a rotary joint using a micro lens array. Fibers are held by a lens system block which is also part of the micro lens system. There is a small air gap between the fiber ends and the micro lens array causing reflections back into the optical fibers.

### SUMMARY OF THE INVENTION

The following description of various embodiments of optical rotary joints and collimator systems is not to be construed in any way as limiting the subject matter of the appended claims.

The embodiments are based on the object of providing a fiber optic collimator, a rotary joint based on the fiber collimator and a method for manufacturing the fiber collimator where the fiber collimator includes a plurality of lenses on a micro lens array.

In an embodiment a fiber optic collimator comprises a lens system having at least one micro lens array. The micro lens array has a first surface with a plurality of micro lenses arranged in a row or a plurality of rows and a second surface opposing the first surface. The second surface is under an oblique angle towards the first surface. The oblique angle is preferably in a range between 5° and 20°, most preferably 7° to 10°. Furthermore the lens system comprises at least one fiber holder attached to the second surface. The fiber holder comprises means for holding optical fibers (light waveguides) like single mode or multimode fibers. The fibers may be aligned by V-grooves and may be fixed by means of an adhesive, bonding, by welding or other methods. Alternatively the fibers may be held in between two plates. The fiber holder has an end surface to which the fiber ends are aligned. This end surface is under said oblique angle to a right angle to the fibers and is in contact with the second surface of the micro lens array. The fiber holder is aligned on the micro lens array in such a way that the oblique angle of the second surface of the micro lens array and the oblique angle of the end surface of the fiber holder compensate each other resulting in the fibers being aligned under a right angle to their corresponding lenses. Due to the oblique angle of the surfaces, light from the fibers enters the surface of the micro lens array under such an oblique angle resulting in a significant reduction of reflections back into the fiber.

In a further embodiment instead of micro lens array a combination of a micro lens array and of an optical spacer are used. Here the microlens array may have a second surface parallel to the first surface. The spacer may be wedge shaped and have a first planar surface attached to the second surface of the micro lens array. The second surface of the spacer is planar and under an oblique angle towards its first surface.

In a preferred embodiment the focal lengths of the individual lenses are adapted, preferably equal to the distance between the lens and the second surface of the micro lens array above the lens. This length is corresponding to the length of the optical path between the fiber and the lens.

In another embodiment the individual lenses are designed so that they get the maximum possible focal length to minimize the optical attenuation of all micro lenses in a row focusing on fibers.

In a further embodiment at least two fiber holders are arranged in parallel on said second surface of the lens array.

In a further embodiment a Rotary joints comprises at least one fiber optic collimator and at least one derotating element like a dove prism.

A method for manufacturing a fiber optic collimator comprises the steps of (i) preparing a micro lens array having a second surface under an oblique angle to a first surface with micro lenses by either grinding and/or polishing the second surface of a micro lens array or directly making such a micro lens array by any manufacturing method of micro lens arrays. Another step (ii) is preparing a fiber holder with attached fibers and an end surface under an oblique angle by either grinding and/or polishing the end surface of a fiber holder or directly making such a fiber holder by any micromechanical/microoptical manufacturing method. Steps (i) and (ii) may be executed at the same time or reversed in their order. The next step (iii) is attaching the fiber holder to the microlens array in such a direction that the oblique angle of the second surface of the micro lens array and the oblique angle of the end surface of the fiber holder compensate each other. Steps (ii) and (iii) may be repeated as many times as necessary to connect all required micro lenses to optical fibers.

### BRIEF DESCRIPTION OF THE DRAWINGS

In the following, the invention will be described by way of example, without limitation of the general inventive concept, on examples of embodiment and with reference to the drawings.

FIG. 1 shows a side view of a collimator system with a micro lens array.

FIG. 2 shows another side view of the collimator system.

FIG. 3 shows a bottom view of the micro lens array.

FIG. 4 shows a side view with marked focus lengths.

FIG. 5 shows a collimator system with a micro lens array and a spacer.

FIG. 6 shows an optical Rotary joint.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

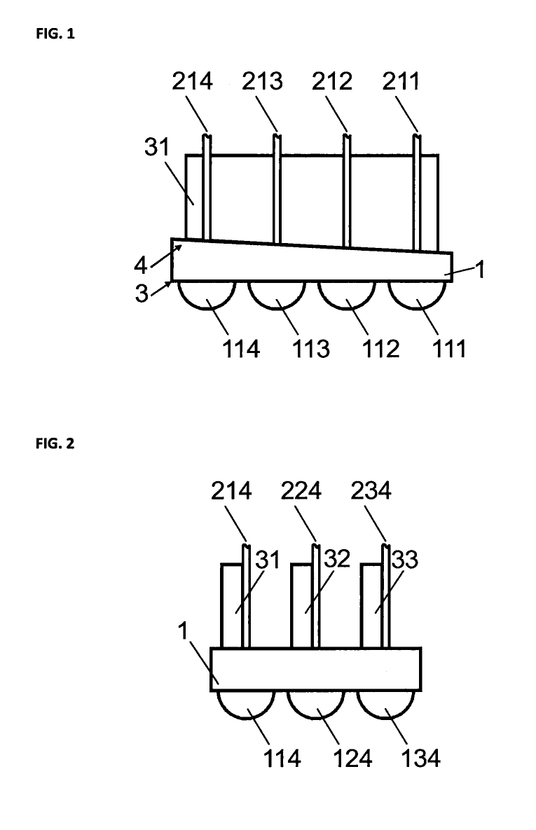

FIG. 1 shows a side view of a collimator system with a micro lens array 1. The micro lens array 1 has a first surface 3 with micro lenses 114, 113, 112 and 111. The opposing second surface 4 is a planar surface under a small angle in relation to the bottom surface. A fiber holder array 31 is attached to the second surface 4 of micro lens array 1. The fiber holder array 31 has a first surface under an angle being adapted to the angle of the second surface of the micro lens array. The fiber holder array 31 is holding individual fibers 214, 213, 212, 211. This results in the individual fibers being arranged under a right angle to their corresponding lenses 114, 113, 112, 111, while the surface angle of the fibers and the corresponding second surface angle of the micro lens array are not under an right angle to the fiber with results in reduction of reflection when light is leaving the fiber and entering the micro lens array or vice versa. Manufacturing is a simple process. The second surface of micro lens array 1 and the corresponding first surface of the fiber holder array 31 have to be grinded and/or polished to obtain the angle.

FIG. 2 shows another side view of the collimator system of FIG. 1 rotated for 90°. Now the fiber holder array 31 is shown from the side. Furthermore additional fiber holder arrays 32 and 33 with their first fiber in the row 224 and 234 are shown.

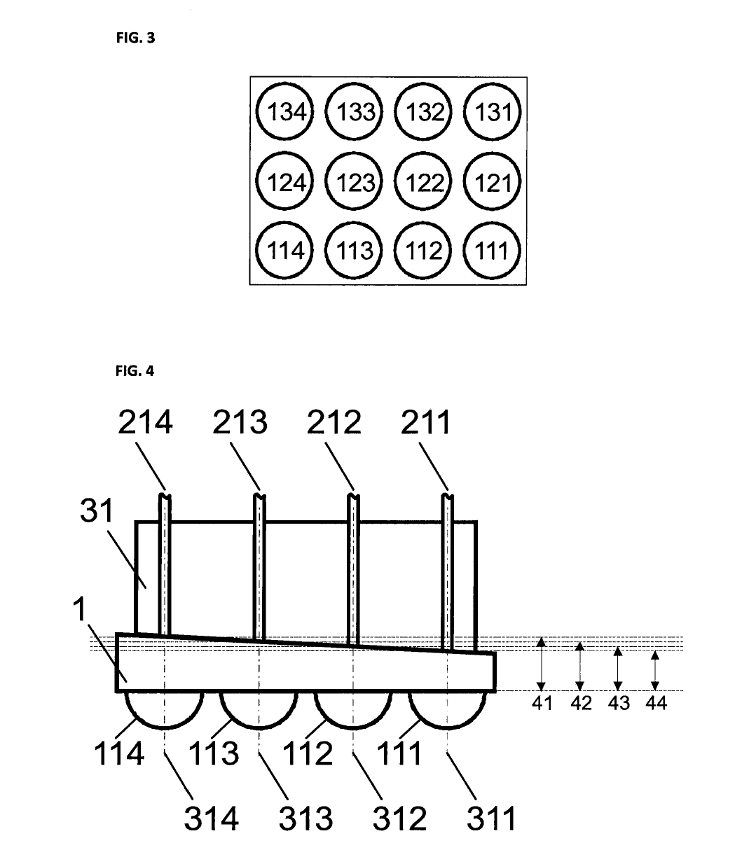

FIG. 3 shows a bottom view from the bottom side of the micro lens array. The micro lenses are identified by their numbers in the rows of 111-114, 121-124, 131-134. Although this configuration shows 3 rows of 4 lenses each, other typical configurations may comprise 3 rows of 9 lenses or any other combination.

FIG. 4 shows a side view like FIG. 1. Each fiber 214, 213, 212, 211 has a longitudinal axis 314, 313, 312, 311 going though the center of the fiber. Furthermore each fiber 214, 213, 212, 211 ending at the first surface of fiber holder 31 has a distance 41, 42, 43, 44 to the second surface of the micro lens array. This distance varies due to the angle of the top second of the micro lens array. If all micro lenses 114, 113, 112, 111 have the same focus length, it is impossible to perfectly focus on all fiber ends, as these fiber ends have different distances to the lenses. To minimize the optical attenuation of all these micro lenses focusing onto fibers the maximum possible, the lenses are designed so that they get the maximum possible focal length. This results in the highest tolerance of the focal position. Furthermore the micro lens array may be made of a material with comparatively high refraction index like silicon. Preferably the material of the fiber holder is adapted to the temperature coefficient of the micro lens array to prevent thermal stress. In the case of a silicon micro lens array this may be also silicon or Pyrex, Borofloat 33, or any other suitable material. Preferably the focal length of lens 114 is adapted to distance 41, focal length of lens 113 is adapted to length 42, focal length of lens 112 is adapted to length 43 and focal length of lens 111 is adapted to length 44.

FIG. 5 shows another embodiment similar to FIG. 1. Here the micro lens array 1 has a second surface 4 which is a planar surface parallel to the bottom surface 3. Attached to the micro lens array 1 is a wedge shaped spacer 2 having a first planar surface 5 oriented to the second surface 4 of the micro lens array 1 and further having an opposing second planar surface 6 which is under a small angle to the first surface 5. The fibers 211-214 are attached to the second surface 6 of the spacer 2. It is obvious that the second surface 4 of the micro lens array must not be parallel to the first surface 3. Instead there can be any combinations of angles of the second surface 4 of the micro lens array and of corresponding angles of the first surface 5 of the spacer, as long as the longitudinal axis of the optical fibers are under a right angle to their corresponding micro lenses of the micro lens array.

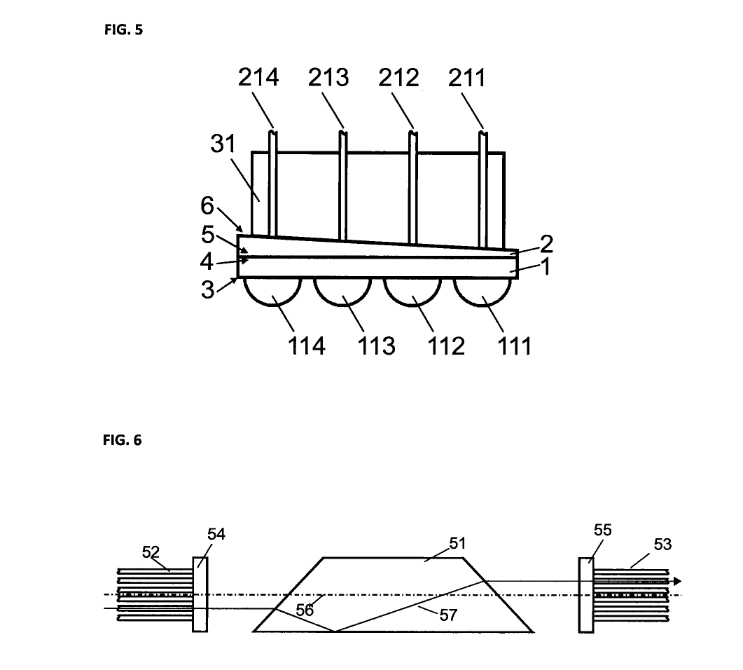

FIG. 6 shows in a schematic form an embodiment of an optical rotary joint having due least one lens system in accordance with the invention at least one of the embodiments described herein. The optical rotary joint shown in FIG. 17 comprises a first lens system 54 for coupling of first light-waveguides 52, and also a second lens system 55 for coupling of second light-waveguides 53. The second collimator arrangement 55 is supported to be rotatable relative to the first collimator arrangement 54 about a rotation axis 56. A derotating element in the form of a Dove prism 51 is located in a beam path between the first collimator arrangement 54 and the second collimator arrangement 55 to compensate for the rotary movement. An example of a ray path of a light ray 57, which starts from one of the first light-waveguides 52 and passes via the first collimator arrangement 54, through the Dove prism 51, and via the second collimator arrangement 55 up to and into one of the second light-waveguides 53 is shown.

It will be appreciated to those skilled in the art having the benefit of this disclosure that this invention is believed to provide optical rotary joints and micro-optical systems, such as collimators, used for multi-channel transmission of optical signals. Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

1 micro lens array
2 spacer
3 first surface of micro lens array
4 second surface of micro lens array
5 first surface of spacer
6 second surface of spacer
31 first fiber holder
32 second fiber holder
33 third fiber holder
41 first distance
42 second distance
43 third distance
44 fourth distance
51 Derotating optical element
52 First light-waveguides
53 Second light-waveguides
54 First collimator arrangement
55 Second collimator arrangement
56 Rotation axis
57 Light ray
111-114 first row of micro lenses
121-124 second row of micro lenses
131-134 third row of micro lenses
211-214 first row fibers
224, 234 fibers
311-314 longitudinal axis of fibers

1. A collimator system comprising:
at least one micro lens array having a first surface with a plurality of micro lenses and a second surface opposing the first surface under an oblique angle;
at least one fiber holder array, each holding in parallel a number of individual optical fibers, each optical fiber defining a longitudinal axis through the center of each fiber, the fiber holder array having a first surface under said oblique angle to the right angle to the longitudinal axis the fibers;
wherein said at least one fiber holder array is attached to said at least one micro lens array in such a way that the oblique angles of the second surface of the micro lens array and the first surface of the fiber holder compensate for each other so that the longitudinal axis of the optical fibers are under a right angle to their corresponding micro lens of the micro lens array.

2. The collimator system according to claim 1, wherein the optical fibers are bonded, glued or welded to the fiber holder.

3. The collimator system according to claim 1, wherein the fiber holder is bonded, glued or welded to the micro lens array.

4. The collimator system according to claim 1, wherein a plurality of fiber holders are attached in parallel to the micro lens array.

5. The collimator system according to claim 1, wherein the focus lengths of the individual lenses are adapted to the distance between the lens and the second surface of the micro lens array above the lens.

6. The collimator system according to claim 1, wherein the individual micro lenses are designed so that they get the maximum possible focal length to minimize the optical attenuation of all micro lenses in a row focusing on fibers.

7. A collimator system comprising:
at least one micro lens array having a first surface with a plurality of micro lenses and a second surface parallel to the first surface;
at least one spacer having a first surface attached to the second surface of the at least one micro lens array and further having a second surface opposing the first surface under an oblique angle;
at least one fiber holder array, each holding in parallel a number of individual optical fibers, each optical fiber defining a longitudinal axis through the center of each fiber, the fiber holder array having a first surface under said oblique angle to the right angle to the longitudinal axis the fibers;
wherein said at least one fiber holder array is attached to said at least one spacer in such a way that the oblique angles of the second surface of the spacer and the first surface of the fiber holder compensate for each other so that the longitudinal axis of the optical fibers are under a right angle to their corresponding micro lens of the micro lens array.

8. The collimator system according to claim 7, wherein the optical fibers are bonded, glued or welded to the fiber holder.

9. The collimator system according to claim 7, wherein the fiber holder is bonded, glued or welded to the micro lens array.

10. The collimator system according to claim 7, wherein a plurality of fiber holders are attached in parallel to the micro lens array.

11. The collimator system according to claim 7, wherein the focus lengths of the individual lenses are adapted to the distance between the lens and the second surface of the micro lens array above the lens.

12. The collimator system according to claim 7, wherein the individual micro lenses are designed so that they get the maximum possible focal length to minimize the optical attenuation of all micro lenses in a row focusing on fibers.

13. Rotary joint comprising at least one collimator system according to claim 1 and at least one derotating element like a dove prism.

14. Rotary joint comprising at least one collimator system according to claim 7 and at least one derotating element like a dove prism.

15. Method for manufacturing a collimator system comprising the steps of
I. preparing a micro lens array having a second surface under an oblique angle to a first surface with micro lenses by either grinding and/or polishing the second surface of the micro lens array or directly making the micro lens array by any manufacturing method of micro lens arrays;
II. preparing a fiber holder with attached fibers and an end surface under an oblique angle by either grinding and/or polishing the end surface of a fiber holder or directly making such a fiber holder by any micromechanical/microoptical manufacturing method;
III. attaching the fiber holder to the microlens array in such a direction that the oblique angle of the second surface of the micro lens array and the oblique angle of the end surface of the fiber holder compensate each other;

16. Method according to claim 15 by repeating steps II. and III.;

17. Method for manufacturing a collimator system comprising the steps of
I. preparing a spacer from an optical material having a second surface under an oblique angle to a first surface by either grinding and/or polishing the second surface of the spacer or directly making such a spacer by any manufacturing method of micro lens arrays;
II. attaching the spacer to a micro lens system;
III. preparing a fiber holder with attached fibers and an end surface under an oblique angle by either grinding and/or polishing the end surface of a fiber holder or directly making such a fiber holder by any micromechanical/microoptical manufacturing method;
IV. attaching the fiber holder to the second surface of the spacer attached to the microlens array in such a direction that the oblique angle of the second surface of the micro lens array and the oblique angle of the end surface of the fiber holder compensate each other;

18. Method according to claim 17 by repeating steps II. and III.;
